(19) United States
(12) Patent Application Publication
(10) Pub. No.: US 2022/0410985 A1
(43) Pub. Date: Dec. 29, 2022

(54) VEHICLE HAVING REDUCED DRAG

(71) Applicant: BRUNEL UNIVERSITY LONDON, Uxbridge Middlesex (GB)

(72) Inventors: Alvin GATTO, Uxbridge Middlesex (GB); Aleksandra Anna REJNIAK, Uxbridge Middlesex (GB)

(21) Appl. No.: 17/781,637

(22) PCT Filed: Dec. 2, 2020
(86) PCT No.: PCT/GB2020/053091

§ 371 Date: Jun. 1, 2022

(30) Foreign Application Priority Data
Dec. 3, 2019 (GB) 1917653.6

(51) Int. Cl. B62D 35/00

(52) U.S. Cl. CPC B62D 35/001

(57) ABSTRACT

A vehicle having reduced drag A vehicle (such as a trailer) has at least one side channel in each side wall and at least two roof channels on either side of a central ridge. Surprisingly, it has been found that providing side channels which are asymmetric (in that the trough of the channel is closer to the top of the channel than the bottom) results in an improved drag coefficient (compared to symmetric channels), as does providing a pitched roof (compared to a flat roof). Furthermore, the combination of asymmetric side channels and a pitched roof gives even better results.

The present invention relates to a vehicle, and in particular to a tractor-trailer where the trailer is adapted to reduce aerodynamic drag.

Heavy goods vehicles (HGVs) comprising a tractor and a trailer are responsible for approximately 17% of the UK's transport CO₂ emissions. At motorway speeds up to 50% of the fuel consumed by a vehicle is used to overcome aerodynamic drag. At the rear of the HGV trailer, separation from the blunt trailing edges forms a large wake immediately behind the vehicle which produces lower pressures that act to resist the vehicle's motion. The rear of the trailer is responsible for 30-35% of the total vehicle drag.

Boat-tail designs for reducing drag are well known (Saltzman, E. and Jr. R. Meyer (1999—A Reassessment of Heavy-Duty Truck Aerodynamic Design Features and Priorities. California: NASA National Technical Information Service). However, these are largely impractical due to the difficulty of loading and unloading a vehicle fitted with such a device through more restricted access to the rear doors. There are also difficulties with the structural integrity of such attachments. In addition, safety and regulatory concerns exist over the stability of vehicles when fitted with these devices.

Over the years there have been many varied designs of panels attached to the rear of trailers with a view to reducing drag. All of these devices suffer from the same issues as above to varying degrees, e.g.: example as seen in U.S. Pat. No. 9,855,982 (a vertical member of the rear frame to extend generally rearward of the trailer) and US 2014/0239669 (a flap that extends from the roof over the end of the trailer). Rejniak, A.A. and Gatto, A. (2019) Application of Lobed Mixers to Reduce Drag of Boat-Tailed Ground Vehicles. Journal of Applied Fluid Mechanics, Vol. 12, No. 6, pp. 1729-1744 describes the use of lobed mixers within a boat-tail as an add-on device to a trailer so that the device protrudes from the base of trailer.

Vortex generators can also be added to the sides of the vehicle in this area (Lay, C. (2013)—Three Dimensional CFD Analysis on Aerodynamic Drag Reduction of a Bluff Tractor Trailer Body using Vortex Generators. 2013 Commercial Vehicles Engineering Congress, p. 10). They work on the principle of mixing enhancement to delay flow separation and therefore achieve drag reduction (Wood, R. M. (2006)—A Discussion of a Heavy Truck Advanced Aerodynamic Trailer System. SOLUS-Solutions and Technologies LLC). The effect of these are relatively small (1-5% fuel savings) but have been used in combination with truncated tail boats to improve drag reduction (e.g.: U.S. Pat. No. 6,959,958). However, these vortex generation devices normally develop high induced drag, reducing their effectiveness.

EP 0272998 A2 (United Technologies Corp.) discloses a projectile having a downstream extending surface of revolution which terminates as a blunt base which has a plurality of circumferentially spaced apart U-shaped downstream extending troughs in its surface. Each trough is essentially aligned with the direction of the bulk fluid flow adjacent the surface in the vicinity of the trough, and intersects the blunt base to form a trough outlet therein. The troughs are appropriately spaced apart, sized and configured over their entire length causing fluid to flow into the space immediately behind the blunt base, thereby reducing base drag on the projectile.

DE 102012010002 A1 (Daimler AG) discloses an invention which is based on a wind deflector for a commercial vehicle, in particular for a semi-trailer with an air guidance system which has at least one air guidance element arranged at a rear to reduce the air resistance of the commercial vehicle. It is proposed that the air guiding element arranged at the rear be designed as a diffuser and that the air guiding system have an aerodynamic inflow body as a further air guiding element which is matched to the diffuser.

In accordance with a first aspect of the invention, there is provided a vehicle including:
a front end,
a rear end,
the front end and the rear end of the vehicle defining the length of the vehicle and being connected by two walls on each side of the vehicle, a roof and a floor, each having an external surface, an internal surface, a depth and a rear edge proximate the rear end of the vehicle,
the maximum width of the vehicle at its rear end being W and the maximum vertical dimension of the vehicle at its rear end being H
wherein
(1) each wall includes at least one side channel, each side channel having a first end distal to the rear edge of the wall and a second end proximate the rear edge of the wall, the length of each side channel being L,
wherein each side channel has
a first depth perpendicular to the external surface of the wall at the first end of the side channel and
a second depth perpendicular to the external surface of the wall at the second end of the side channel,
the first depth and the second depth being connected by a side channel floor,
wherein each side channel has a side channel opening proximate the rear edge of the vehicle wall, the opening having a profile defined by
a first peak which is the point on the side channel proximate the rear edge of the vehicle closest to the external surface of the wall and closest to the vehicle floor,
a second peak which is the point on the side channel proximate the rear edge of the vehicle closest to the external surface of the wall and closest to the vehicle roof,
and a trough which is the point on the side channel proximate the rear edge of the vehicle at the second depth of the side channel on the side channel floor,
wherein the distance between the first and second peaks measured along a notional line parallel to the rear edge of the vehicle wall is defined as p (with p being the same or different for each side channel),
wherein the distance from the trough to said notional line parallel to said rear edge measured along a notional line perpendicular to said rear edge is defined as h (with h being the same or different for each side channel),
wherein the distance from the first peak to a point at which said notional lines bisect is defined as p1 (with p1 being the same or different for each side channel),
wherein the distance from the second peak to a point at which said notional lines bisect is defined as p2 (with p2 being the same or different for each side channel), such that p=p1+p2,
and wherein in each case p1 is not equal to p2,
and/or wherein
(2) the roof includes at least two roof channels, one on either side of a central ridge which ridge is disposed parallel to the length of the vehicle, the ridge having a first end distal to the rear edge of the vehicle and a second end proximate the rear edge of the vehicle, the length of the ridge and of each roof channel being L′,
wherein each roof channel has a trough of length L′ which is disposed parallel to the central ridge, wherein at the end of each roof channel distal to the rear edge of the vehicle the trough terminates at the same height as the roof and the central ridge, and at the other end of the roof channel the trough is at a depth of h′ below the height of the central ridge, and wherein the distance from the trough of one roof channel to the trough of the other at the rear edge of the vehicle is W′.

In a preferred embodiment, p1>p2. It will be appreciated that p2 is a continuous variable in the range 0<p2<p/2. However, in a preferred embodiment p2 is less than or equal to p/4.

Surprisingly, it has been found that providing side channels which are asymmetric (in that, preferably, the trough of the channel is closer to the top of the vehicle than the bottom) results in an improved drag coefficient (compared to symmetric channels), as does providing a pitched roof channel (compared to a flat roof). Furthermore, the combination of asymmetric side channels and a pitched roof channel gives even better results.

The side walls can in one embodiment include more than one channel, and the values of peaks and troughs of the plurality of channels may be irregular in shape, with the value of h varying and/or the value of p, p1 and p2 varying. Ideally however the two side walls have an identical configuration of channels and are identical or closely similar in configuration so that the drag on each side of the vehicle is broadly symmetrical.

In a preferred embodiment, the vehicle is a combination of a tractor and trailer. It could however be a powered vehicle such as a bus or a train or a boat or a car.

The inventive arrangement has the advantage that it does not protrude over the existing base of the vehicle and so avoids any concerns over vehicle stability and safety or structural integrity of the design. It is instead embedded in the vehicle itself so there are no significant safety and regulatory disadvantages. There is also the added advantage that it does not interfere with the loading and unloading of the vehicle.

In accordance with an alternative aspect of the invention, there is provided a vehicle including:
a front end,
a rear end,
the front end and the rear end of the vehicle defining the length of the vehicle and being connected by at least one vehicle wall having an external surface, an internal surface, a depth and a rear edge at the rear end of the vehicle,
the maximum width of the vehicle at its rear end being W and the maximum vertical dimension of the vehicle at its rear end being H
wherein the vehicle wall includes a plurality of channels, each having a first end distal to the rear edge of the vehicle wall and a second end proximate the rear edge of the vehicle wall, the length of each channel being L,
wherein each channel has a channel opening proximate the rear edge of the vehicle wall,
whereby when the vehicle is moving, air flowing along the vehicle wall flows down each of the channels and out of each of the channel openings, thereby reducing drag and increasing the fuel efficiency of the vehicle.

A preferred embodiment of the invention will now be described with reference to and as illustrated in the accompanying drawings, in which:

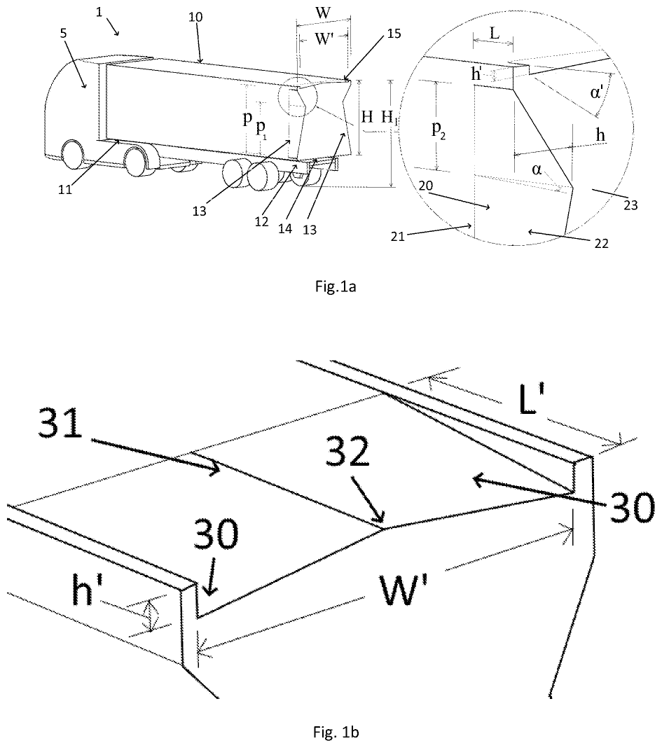

FIG. 1a is a schematic diagram of a vehicle comprising a tractor and trailer in accordance with the invention, with an enlarged view (in inset) showing the details of the invention;

FIG. 1b is a schematic diagram showing the roof of the trailer of FIG. 1a in more detail;

FIG. 1c is a schematic diagram showing the shape profile of the roofline of the trailer of FIG. 1a (in a plan view from the rear);

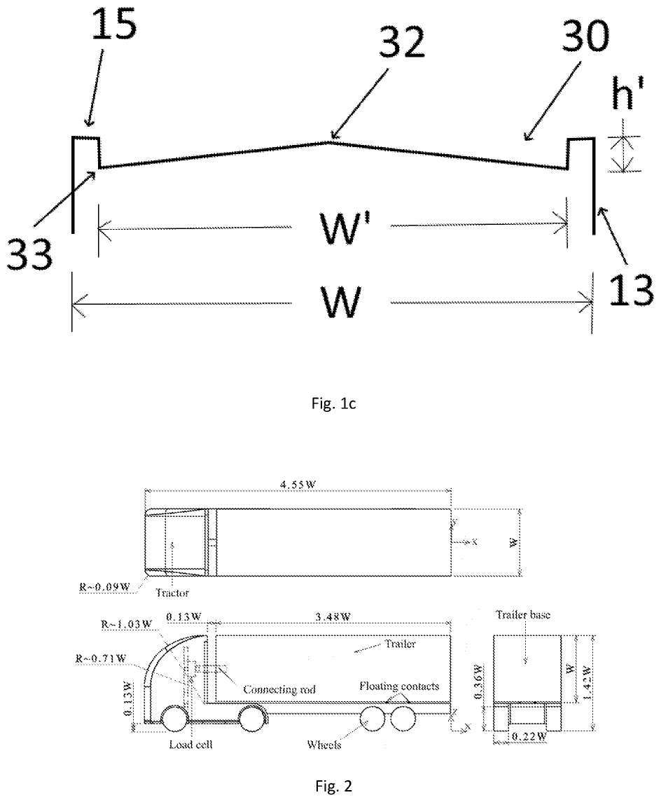

FIG. 2 is a schematic diagram of the 1/24^{th}-scale model used in Examples 1 to 12 below; and

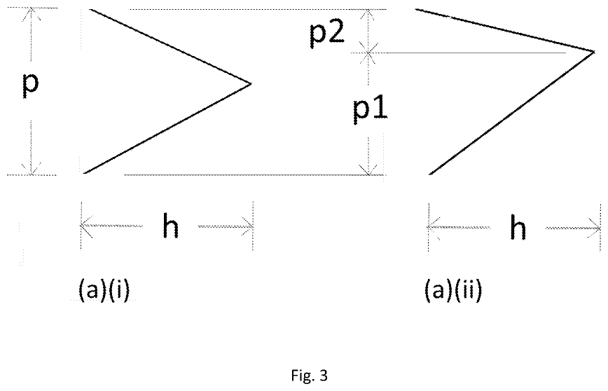

FIG. 3 is a schematic diagram showing the shape profile of a prior art channel (a)(i) and a shape profile of a channel of a trailer in accordance with the invention (a)(ii).

Turning to FIG. 1a, a vehicle 1 comprises a tractor 5 and trailer 10 coupled to tractor 5. Trailer 10 has front end 11 and rear end 12 and is of a conventional cuboid configuration with four trailer walls along its length (two side walls, a roof and a floor) which terminate at rear end 12 in side edges 13, bottom edge 14 and top edge 15. Trailer 10 has width W and maximum vertical dimension H as shown in FIG. 1a. Note that H is not the same as the height of trailer 10 or vehicle 1 above the ground, which is shown instead as H1. It will be appreciated that H1 depends upon the height of the trailer bottom section (including the wheels) whereas H is a fixed dimension for any particular trailer. It is the value of H that is important in the definition of the present invention and not the value of H1.

In the illustrated embodiment, the side walls of trailer 10 are modified to each include a single channel 20. The roof is modified to include two roof channels 30, one on either side of a single roof peak 32 forming a ridge 31 of length L′ as will be described below. The trailer floor is unmodified to allow for unimpeded loading of goods into trailer 10. A trailer door or ramp may be attached to bottom edge 14 (not shown).

Channels 20 each have front end 21 and rear end 22 with length L. Each of channels 20 is shallow at the front end 21 and deeper at rear end 22, so that the floor of each channel 20 is angled away from the plane of the trailer wall at angle α. Each channel has an opening 23 at side edge 13.

The width of each channel 20 from peak-to-peak is labelled p on FIG. 1a. The point at which the floor of each channel 20 meets side edge 13 forms a trough. This trough is closer to the roof of trailer 10 than it is to the floor of trailer 10, thereby forming an asymmetric channel 20 which (as can be seen below) results in an improved drag coefficient. The extent of the asymmetry can be measured by comparing the distance p1 from the lower channel peak (i.e. closest to the vehicle floor) to the trough and the distance p2 from the trough to the upper channel peak (i.e. the peak closest to the vehicle roof).

For symmetric channels (not in accordance with the invention) p1=p2 and this is illustrated in (a)(i) in FIG. 3. By contrast, for the inventive vehicle p1>p2 as shown on (a)(ii) of FIG. 3 and also in FIG. 1a.

Turning to FIGS. 1a, 1b and 1c, the roof of trailer 10 has two roof channels 30 formed therein on either side of a single central ridge 31 of length L′ parallel to the length of trailer 10. Ridge 31 is at the same height as the rest of the roof of trailer 10 and roof channels 30 are ‘cut away’ in that they are lower in height (although in practice it will be appreciated that the roof is formed with channels 30 therein rather than any actual cutting taking place).

The profile of the roof at roof edge 15 where it meets rear end 12 is best seen from FIGS. 1b and 1c. It can be seen that roof channels 30 are defined by a roof trough 33 at a depth h′ below the roofline where roof trough 33 meets rear end 12. The distance between roof troughs 33 is W′ which is slightly less than the width W of trailer 10.

Roof peak 32 is in the centre of the roof and is at the same height as the roofline and at the end of ridge 31 proximate roof edge 15. The end of each roof channel 30 distal to roof edge 15 is at the same height as the roofline and so the line forming the trough of each roof channel 30 along its length L′ is at an angle α′ to the roofline.

In an alternative embodiment (not shown) each side wall may include more than one channel in which case the profile of the channel openings at side edge 13 form a series of peaks and troughs.

Preferred ranges for angle α height h, width p and length L are given in Table 1 below:

| α | 1-30 degrees |
|---|---|
| h | 0.001W-0.3W and/or 0.001H-0.3H |
| P | 0.001W-0.3W and/or 0.001H-0.3H |
| L | 0.001W-0.5W and/or 0.001H-0.5H |

More preferred ranges for angle α, height h, width p and length L are given in Table 2 below:

| α | 2-30 degrees |
|---|---|
| h | 0.008W-0.2W and/or 0.005H-0.2H |
| P | 0.008W-0.2W and/or 0.005H-0.2H |
| L | 0.008W-0.2W and/or 0.005H-0.2H |

In use, tractor 5 is driven to tow trailer 10 behind it. Air flowing down the trailer side walls enters each channel 20 at front end 21, flow down length L of channel 20, and exits channel 20 at rear end 22 through channel opening 23.

Air flowing along the pitched roof profile flows along roof channels 30 and exits at roof edge 15.

In an alternative embodiment, channels 20 and 30 may be embedded into the walls and roof of a driven vehicle such as a bus or boat or train or car.

### EXAMPLES

A simplified 1/24^{th}-scale model as illustrated in FIG. 2 was used for all examples. This baseline model is representative of a Heavy Goods Vehicle and constructed in two parts; a tractor and trailer bottom section, and the trailer. Overall dimensions were 500 mm long, 156 mm high and 110 mm wide. The trailer was attached to the tractor as a separate section via a load cell and sliding contacts to allow the trailer to ‘free-float’ on the trailer bottom. This allowed measurement of trailer drag. These tests were conducted in an open-circuit wind tunnel with a closed test section measuring 1.3 m long, 0.46 m wide, and 0.36 m high. A moving belt facility of width 0.36 m was used to simulate the influence of a moving ground. The solid blockage, the ratio of the model frontal area divided by the wind tunnel cross-sectional area, was 10.3%. The freestream uniformity, turbulence intensity, and height wise velocity consistency at a central test section (empty) position were ±1%, 0.5%, and within ±0.05U_{∞} (0.09 W above the moving ground) respectively.

The drag force, in Newtons, was measured for both the baseline vehicle without any channels and for the modified vehicle with channels embedded. All measurements were repeated three times to assess variability.

The baseline drag coefficient, Cd_{baseline}, for the vehicle (without channels) is calculated as:

$$C {d}_{b a s e l i n e} = \frac{{D}_{b a seline}}{0.5 * ρ * {V}^{2} * S}$$

and the drag coefficient for the modified vehicle, Cd, is calculated as:

$$C d = \frac{D}{0.5 * ρ * {V}^{2} * S}$$

Where,

D_{baseline}=Drag force of baseline vehicle without channels, N

D=Drag force of baseline vehicle with channels, N

ρ=air density, kg/m³

V=flow velocity, m/s

S=Vehicle frontal area, m²

Results can be reported as either the absolute drag coefficient, Cd, or as the change in drag coefficient,

$$\% Δ Cd = ( \frac{Cd - {Cd}_{b a seline}}{{Cd}_{b a seline}} ) \times 100$$

Results

| | Example 1 | | Example 2 | | | | Example 4 | | Example 5 | |
|---|---|---|---|---|---|---|---|---|---|---|
| | Top and sides | | Top and sides | | | | Sides only | | Sides only | |
| | inventive | | comparative | | Example 3 | | inventive | | comparative | |
| | design | | design | | Top only | | design | | design | |
| Scale | 1/24^{th} | | 1/24^{th} | | 1/24^{th} | | 1/24^{th} | | 1/24^{th} | |
| W | 110 | mm | 110 | mm | 110 | mm | 110 | mm | 110 | mm |
| H | 110 | mm | 110 | mm | 110 | mm | 110 | mm | 110 | mm |
| Total model | 500 | mm | 500 | mm | 500 | mm | 500 | mm | 500 | mm |
| length | | | | | | | | | | |
| Free stream wind | 38 | m/s | 38 | m/s | 38 | m/s | 38 | m/s | 38 | m/s |
| velocity, V | | | | | | | | | | |

| | | | | | |
|---|---|---|---|---|---|
| Reynolds | 2.84 × 10\hat{ }5 | 2.84 × 10\hat{ }5 | 2.84 × 10\hat{ }5 | 2.84 × 10\hat{ }5 | 2.84 × 10\hat{ }5 |
| Number, Re_{W} | | | | | |

| | | | | | | | | | | |
|---|---|---|---|---|---|---|---|---|---|---|
| S (vehicle | 0.0172 | m\hat{ }2 | 0.0172 | m\hat{ }2 | 0.0172 | m\hat{ }2 | 0.0172 | m\hat{ }2 | 0.0172 | m\hat{ }2 |
| frontal area) | | | | | | | | | | |

| | | | | | | | | | |
|---|---|---|---|---|---|---|---|---|---|
| L | 0.13 | W | 0.13 | W | n/a | 0.13 | W | 0.13 | W |
| h | 0.045 | W | 0.045 | W | n/a | 0.045 | W | 0.045 | W |

| | | | | | | | | |
|---|---|---|---|---|---|---|---|---|
| L′ | 0.08 | W | 0.08 | W | 0.08 | W | n/a | n/a |
| h′ | 0.03 | W | 0.03 | W | 0.03 | W | n/a | n/a |
| W′ | 105 | mm | 105 | mm | 105 | mm | n/a | n/a |

| | | | | | |
|---|---|---|---|---|---|
| α | 20 | 20 | 20 | 20 | 20 |
| α′ | 20 | 20 | 20 | 20 | 20 |
| p/p1/p2 | p = 1 W | p = 1 W | p = n/a | p = 1 W | p = 1 W |
| | p1 = 3p/4, | p1 = p/2, | | p1 = 3p/4, | p1 = p/2, |
| | p2 = p/4 | p2 = p/2 | | p2 = p/4 | p2 = p/2 |
| −Δ Cd | 9.7% | 7.4% | 1.8% | 4.9% | 3.2% |

| | Example 6 | | Example 7 | | | | Example 9 | | Example 10 | | Example 11 | | Example 12 | |
|---|---|---|---|---|---|---|---|---|---|---|---|---|---|---|
| | Top and sides | | Top and sides | | | | Sides only | | Sides only | | Top and sides | | Sides only | |
| | inventive | | comparative | | Example 8 | | inventive | | comparative | | inventive | | inventive | |
| | design | | design | | Top only | | design | | design | | design | | design | |
| Scale | 1/24^{th} | | 1/24^{th} | | 1/24^{th} | | 1/24^{th} | | 1/24^{th} | | 1/24^{th} | | 1/24^{th} | |
| W | 110 | mm | 110 | mm | 110 | mm | 110 | mm | 110 | mm | 110 | mm | 110 | mm |
| H | 110 | mm | 110 | mm | 110 | mm | 110 | mm | 110 | mm | 110 | mm | 110 | mm |
| Total model | 500 | mm | 500 | mm | 500 | mm | 500 | mm | 500 | mm | 500 | mm | 500 | mm |
| length | | | | | | | | | | | | | | |
| Free stream wind | 38 | m/s | 38 | m/s | 38 | m/s | 38 | m/s | 38 | m/s | 38 | m/s | 38 | m/s |
| velocity, V | | | | | | | | | | | | | | |
| Reynolds | 2.84 × 10\hat{ }5 | | 2.84 × 10\hat{ }5 | | 2.84 × 10\hat{ }5 | | 2.84 × 10\hat{ }5 | | 2.84 × 10\hat{ }5 | | 2.84 × 10\hat{ }5 | | 2.84 × 10\hat{ }5 | |
| Number, Re_{W} | | | | | | | | | | | | | | |
| S (vehicle | 0.0172 | m\hat{ }2 | 0.0172 | m\hat{ }2 | 0.0172 | m\hat{ }2 | 0.0172 | m\hat{ }2 | 0.0172 | m\hat{ }2 | 0.0172 | m\hat{ }2 | 0.0172 | m\hat{ }2 |
| frontal area) | | | | | | | | | | | | | | |

| | | | | | | | | | | | | | |
|---|---|---|---|---|---|---|---|---|---|---|---|---|---|
| L | 0.11 | W | 0.11 | W | n/a | 0.11 | W | 0.11 | W | 0.11 | W | 0.11 | W |
| h | 0.045 | W | 0.045 | W | n/a | 0.045 | W | 0.045 | W | 0.045 | W | 0.045 | W |

| | | | | | | | | | | | |
|---|---|---|---|---|---|---|---|---|---|---|---|
| L′ | 0.06 | W | 0.06 | W | 0.06 | W | n/a | n/a | 0.06 | W | n/a |
| h′ | 0.03 | W | 0.03 | W | 0.03 | W | n/a | n/a | 0.03 | W | n/a |
| W′ | 105 | mm | 105 | mm | 105 | mm | n/a | n/a | 105 | mm | n/a |

| | | | | | | | |
|---|---|---|---|---|---|---|---|
| α | 25 | 25 | 25 | 25 | 25 | 25 | 25 |
| α′ | 25 | 25 | 25 | 25 | 25 | 25 | 25 |
| p/p1/p2 | p = 1 W | p = 1 W | p = n/a | p = 1 W | p = 1 W | p = 1 W | p = 1 W |
| | p1 = p/6 | p1 = p/2 | | p1 = p/6 | p1 = p/2, | p1 = 3p/4 | p1 = 3p/4, |
| | p2 = 5p/6 | p2 = p/2 | | p2 = 5p/6 | p2 = p/2 | p2 = p/4 | p2 = p/4 |
| −Delta Cd | 6.5% | 4.5% | 2.4% | 1.8% | 0.7% | 5.0% | 2.2% |

In Examples 1 to 5 the effect of the design is demonstrated for α=20°. As shown in Example 1, a reduction in drag coefficient, −ΔCd, of 9.7% is achieved when a single asymmetrical channel (p2=p/4) is embedded on both sides of the trailer with a peak roof. This can be compared to Example 2 where a single symmetrical channel (p2=p/2) is embedded on both sides of the trailer with a peak roof and a reduction in drag coefficient, −ΔCd, of only 7.4% is achieved.

The contribution of each of the channels embedded in the top and sides of the trailer can also be seen. As shown in Example 4, a reduction in drag coefficient, −ΔCd, of 4.9% is achieved when a single asymmetrical channel (p2=p/4) is embedded on both sides of the trailer with no peak roof. This can be compared to Example 5 where a single symmetrical channel (p2=p/2) is embedded on both sides of the trailer with no peak roof and a reduction in drag coefficient, −ΔCd, of only 3.2% is achieved.

The effect of the combination of the designs for the two sides and the roof are seen by comparison of Examples 3 and 4 with Example 1. The simple addition of the designs on the roof in Example 3 and the sides only in Example 4 would predict a reduction in drag coefficient, −ΔCd, of 6.7%. However, this combined design as measured in Example 1 gives a reduction in drag coefficient, −ΔCd, of 9.7% thereby demonstrating the surprisingly increased benefit of combining the roof and sides designs.

In Examples 6-12 the effect of effect of the angle α=25° is demonstrated. As shown in Example 6, a reduction in drag coefficient, −ΔCd, of 6.5% is achieved when a single asymmetrical channel (p2=5p/6) is embedded on both sides of the trailer with a peak roof. This can be compared to Example 7 where a single symmetrical channel (p2=p/2) is embedded on both sides of the trailer with a peak roof and a reduction in drag coefficient, −ΔCd, of only 4.5% is achieved.

The contribution of each of the channels embedded in the top and sides of the trailer can also be seen. As shown in Example 9, a reduction in drag coefficient, −ΔCd, of 1.8% is achieved when a single asymmetrical channel (p2=5p/6) is embedded on both sides of the trailer with no peak roof. This can be compared to Example 10 where a single symmetrical channel (p2=p/2) is embedded on both sides of the trailer with no peak roof and a reduction in drag coefficient, −ΔCd, of only 0.7% is achieved.

The effect of the combination of the designs for the two sides and the roof are seen by comparison of Examples 8 and 9 with Example 6. The simple addition of the designs on the roof in Example 8 and the sides only in Example 9 would predict a reduction in drag coefficient, −ΔCd, of 4.2%. However, this combined design as measured in Example 6 gives a reduction in drag coefficient, −ΔCd, of 6.5% thereby demonstrating the surprisingly increased benefit of combining the sides and roof designs.

As shown in Example 11, a reduction in drag coefficient, −ΔCd, of 5.0% is achieved when a single asymmetrical channel (p2=p/4) is embedded on both sides of the trailer with a peak roof. This can be compared again to Example 7 where a single symmetrical channel (p2=p/2) is embedded on both sides of the trailer with a peak roof and a reduction in drag coefficient, −ΔCd, of only 4.5% is achieved.

The contribution of each of the channels embedded in the top and sides of the trailer can also be seen. As shown in Example 12, a reduction in drag coefficient, −ΔCd, of 2.2% is achieved when a single asymmetrical channel (p2=p/4) is embedded on both sides of the trailer with no peak roof. This can be again compared to Example 10 where a single symmetrical channel (p2=p/2) is embedded on both sides of the trailer with no peak roof and a reduction in drag coefficient, −ΔCd, of only 0.7% is achieved.

The effect of the combination of the designs for the two sides and the roof are seen by comparison of Examples 8 and 12 with Example 11. The simple addition of the designs on the roof in Example 8 and the sides only in Example 12 would predict a reduction in drag coefficient, −ΔCd, of 4.6%. However, this combined design as measured in Example 11 gives a reduction in drag coefficient, −ΔCd, of 5.0% thereby demonstrating the surprisingly increased benefit of combining the sides and roof designs.

All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

The disclosures in UK patent application number 1917653.6, from which this application claims priority, and in the abstract accompanying this application are incorporated herein by reference.

1. A vehicle including:
a front end,
a rear end,
the front end and the rear end of the vehicle defining the length of the vehicle and being connected by two walls on each side of the vehicle, a roof and a floor, each having an external surface, an internal surface, a depth and a rear edge proximate the rear end of the vehicle,
the maximum width of the vehicle at its rear end being W and the maximum vertical dimension of the vehicle at its rear end being H,
wherein
(1) each wall includes at least one side channel, each side channel having a first end distal to the rear edge of the wall and a second end proximate the rear edge of the wall, the length of each side channel being L,
wherein each side channel has
a first depth perpendicular to the external surface of the wall at the first end of the side channel and
a second depth perpendicular to the external surface of the wall at the second end of the side channel,
the first depth and the second depth being connected by a side channel floor,
wherein each side channel has a side channel opening proximate the rear edge of the vehicle wall, the opening having a profile defined by
a first peak which is the point on the side channel proximate the rear edge of the vehicle closest to the external surface of the wall and closest to the vehicle floor,
a second peak which is the point on the side channel proximate the rear edge of the vehicle closest to the external surface of the wall and closest to the vehicle roof,
and a trough which is the point on the side channel proximate the rear edge of the vehicle at the second depth of the side channel on the side channel floor,
wherein the distance between the first and second peaks measured along a notional line parallel to the rear edge of the vehicle wall is defined as p (with p being the same or different for each side channel),
wherein the distance from the trough to said notional line parallel to said rear edge measured along a notional line perpendicular to said rear edge is defined as h (with h being the same or different for each side channel),
wherein the distance from the first peak to a point at which said notional lines bisect is defined as p1 (with p1 being the same or different for each side channel),
wherein the distance from the second peak to a point at which said notional lines bisect is defined as p2 (with p2 being the same or different for each side channel),
such that p=p1+p2,
and wherein in each case p1 is not equal to p2,
and/or wherein
(2) the roof includes at least two roof channels, one on either side of a central ridge which ridge is disposed parallel to the length of the vehicle, the ridge having a first end distal to the rear edge of the vehicle and a second end proximate the rear edge of the vehicle, the length of the ridge and of each roof channel being L′,
wherein each roof channel has a trough of length L′ which is disposed parallel to the central ridge, wherein at the end of each roof channel distal to the rear edge of the vehicle the trough terminates at the same height as the roof and the central ridge, and at the other end of the roof channel the trough is at a depth of h′ below the height of the central ridge, and
wherein the distance from the trough of one roof channel to the trough of the other at the rear edge of the vehicle is W′.

2. The vehicle of claim 1, wherein the second depth is greater than the first depth such that an angle a subtended by an axis along the length of the side channel floor and an axis parallel to the external surface of the vehicle wall is from 1 to 30°.

3. The vehicle of claim 2, wherein the angle a is substantially the same for each side channel.

4. The vehicle of claim 1, wherein each roof channel trough is disposed at an angle α′ from the plane of the vehicle roof wherein α′ is from 1 to 30°.

5. The vehicle of claim 1 wherein p1 or p2 is p/3, p/4, p/5 or p/6.

6. The vehicle of claim 1 wherein p1 or p2 is less than or equal to p/4.

7. The vehicle of claim 1 wherein p1>p2.

8. The vehicle of claim 1 wherein there is a single side channel in each side wall.

9. The vehicle of claim 1, wherein there are a plurality of side channels in each side wall, with the same number of side channels in each.

10. The vehicle of claim 9, wherein the peaks and troughs of the plurality of side channels are irregular in shape, with the value of h varying and/or the value of p, p1 and p2 varying, but wherein the two side walls have an identical configuration of side channels.

11. The vehicle of claim 1 wherein the value of h for each side channel is independently from 0.001 W to 0.3 W.

12. The vehicle of claim 1, wherein the value of h for each side channel is independently from 0.001 H to 0.3 H.

13. The vehicle of claim 1, wherein the value of each p is independently from 0.001 W to 0.3 W.

14. The vehicle of claim 1, wherein the value of each p is independently from 0.001 H to 0.3 H.

15. The vehicle of claim 1, wherein the value of L for each side channel or L′ for each roof channel is independently from 0.001 W to 0.5 W.

16. The vehicle of claim 1, wherein the value of L for each side channel or L′ for each roof channel is independently from 0.001 H to 0.5 H.

17. The vehicle of claim 1, wherein the value of h′ for each roof channel is from 0.001 W to 0.3 W.

18. The vehicle of claim 1, wherein the value of h′ for each roof channel is from 0.001 H to 0.3 H.

19. The vehicle of claim 1, wherein the side and roof channels do not extend beyond the rear edge of the walls.

20. The vehicle of claim 1, wherein the side channels are disposed along only a part of said wall.

21. The vehicle of claim 1, wherein the vehicle is a trailer, a bus, a train, a boat, or a car.
